(19) United States
(12) Patent Application Publication
(10) Pub. No.: US 2025/0201832 A1
(43) Pub. Date: Jun. 19, 2025

(54) NEGATIVE ELECTRODE ACTIVE MATERIAL AND ALL SOLID BATTERY

(71) Applicant: TAIYO YUDEN CO., LTD., Tokyo (JP)

(72) Inventors: Taiki SUEMATSU, Tokyo (JP); Daigo ITO, Tokyo (JP)

(73) Assignee: TAIYO YUDEN CO., LTD., Tokyo (JP)

(21) Appl. No.: 19/070,028

(22) Filed: Mar. 4, 2025

Related U.S. Application Data
(63) Continuation of application No. PCT/JP2023/031321, filed on Aug. 29, 2023.

(30) Foreign Application Priority Data
Sep. 29, 2022 (JP) 2022-156872

(51) Int. Cl. H01M 4/485; C01G 35/00; H01M 4/02; H01M 10/0562; H01M 50/434

(52) U.S. Cl. CPC H01M 4/485; C01G 35/006; H01M 10/0562; H01M 50/434; C01P 2002/50; C01P 2002/76; C01P 2006/40; H01M 2004/021; H01M 2004/027; H01M 2300/0071

(57) ABSTRACT

A negative electrode active material is provided. A composition is expressed by a formula AlNb₁₁₋ₓMₓO₂₉. 0.5<x<5 is satisfied. The M is a transition metal element with a valence of 4 or more.

### CROSS-REFERENCE TO RELATED APPLICATION

This application is a continuation application of PCT/JP2023/031321 filed on Aug. 29, 2023, which claims priority to Japanese Patent Application No. 2022-156872 filed on Sep. 29, 2022, the contents of which are herein wholly incorporated by reference.

### FIELD

The present invention relates to a negative electrode active material and an all solid battery.

### BACKGROUND

In recent years, all solid batteries have been used as secondary batteries with high energy density. Electrode active materials for use in all solid batteries are being developed (see, for example, Japanese Patent Application Publication No. 2010-287496 hereinafter referred to as Patent Document 1, International Publication No. 2022/080083 hereinafter referred to as Patent Document 2, and Appl. Mater. Interface. 2019; 11(6): 6089-6096 hereinafter referred to as Non-Patent Document 1).

### SUMMARY OF THE INVENTION

According to an aspect of the present invention, there is provided a negative electrode active material is characterized in that a composition is expressed by a formula AlNb₁₁₋ₓMₓO₂₉, 0.5<x<5 is satisfied, and the M is a transition metal element with a valence of 4 or more.

According to another aspect of the present invention, there is provided an all solid battery is characterized by including: an oxide-based solid electrolyte layer; a first electrode layer that is formed on a first main face of the oxide-based solid electrolyte layer and includes a positive electrode active material; and a second electrode layer that is formed on a second main face of the oxide-based solid electrolyte layer and includes any of the above negative electrode active materials.

### BRIEF DESCRIPTION OF THE DRAWINGS

FIG. 1 is a schematic cross-sectional view illustrating a basic structure of an all solid battery;

FIG. 2 is a schematic cross-sectional view illustrating an all solid battery in accordance with an embodiment;

FIG. 3 illustrates a schematic cross sectional view illustrating another all solid battery;

FIG. 4 illustrates a flow of a manufacturing method of an all solid battery;

FIG. 5A and FIG. 5B illustrate a stacking process;

FIG. 6 shows results of a charge/discharge test of Comparative Example 1; and

FIG. 7 shows results of a charge/discharge test of Example 3.

### DETAILED DESCRIPTION

Recently, secondary batteries have been used in various fields. Secondary batteries using electrolyte liquid have problems such as electrolyte liquid leakage. Therefore, development of all solid batteries that have a solid electrolyte and other components that are also solid is being developed. Solid electrolytes have a wider potential window (stability over a wide range of potentials) than electrolyte liquid. In particular, oxide-based solid electrolytes, which exhibit high ionic conductivity through sintering, have the advantage of having a wider potential window than electrolyte liquid and other solid electrolytes, and being relatively stable in the air.

The characteristics required for electrode active materials applied to all solid batteries using oxide-based solid electrolytes are not only basic battery characteristics such as Coulomb efficiency, cycle characteristics, and capacity, but also that interdiffusion reactions are unlikely to occur when co-sintered with the solid electrolyte, and that volume change during charging and discharging is small. In particular, in ultra-small all solid batteries using oxide-based solid electrolytes, the negative electrode active material is required to have a high volumetric capacity, high stability in batch firing, and good cycle characteristics.

Electrode active materials with high volumetric capacity include TiNb₂O₇, disclosed in Patent Document 1, and AlNb₁₁O₂₉, disclosed in Non-Patent Document 1.

TiNb₂O₇ has problems with cycle and rate characteristics when applied to all solid batteries. Although AlNb₁₁O₂₉ has higher rate characteristics than TiNb₂O₇, it is still not sufficient, and cycle characteristics are also a problem. Patent Document 2 discloses an example of improving rate and cycle characteristics by applying a negative electrode active material in which both the Al site and Nb site of AlNb₁₁O₂₉ are substituted with different elements in an all solid battery using a sulfide-based solid electrolyte. However, the Al site is mainly substituted with a divalent metal element, and the substituted element is easily diffused due to mutual reactions during the firing process in an all solid battery using an oxide-based solid electrolyte, which results in a decrease in rate characteristics.

A description will be given of an embodiment with reference to the accompanying drawings.

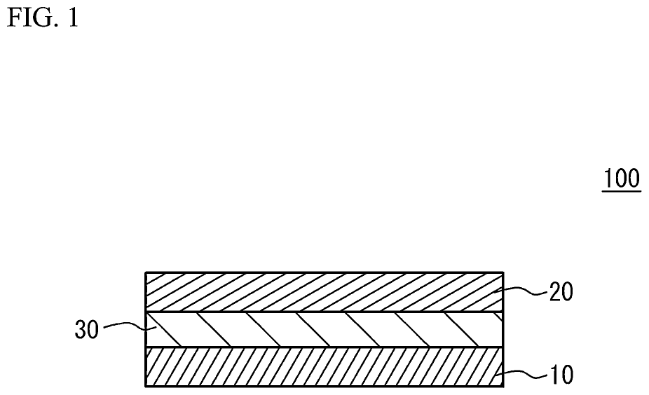

(Embodiment) FIG. 1 illustrates a schematic cross section of a basic structure of an all solid battery 100 in accordance with an embodiment. As illustrated in FIG. 1, the all solid battery 100 has a structure in which a first internal electrode 10 (first internal electrode layer) and a second internal electrode 20 (second internal electrode layer) sandwich a solid electrolyte layer 30. The first internal electrode 10 is provided on a first main face of the solid electrolyte layer 30. The second internal electrode 20 is provided on a second main face of the solid electrolyte layer 30.

When the all solid battery 100 is used as a secondary battery, one of the first internal electrode 10 and the second internal electrode 20 is used as a positive electrode and the other is used as a negative electrode. In the embodiment, as an example, the first internal electrode 10 is used as a positive electrode, and the second internal electrode 20 is used as a negative electrode.

A main component of the solid electrolyte layer 30 is a solid electrolyte having ion conductivity. The solid electrolyte of the solid electrolyte layer 30 is, for example, an oxide-based solid electrolyte having lithium ion conductivity. The solid electrolyte is, for example, a phosphate-based solid electrolyte having a NASICON structure. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like may be used.

The first internal electrode 10 used as the positive electrode contains a substance having an olivine crystal structure as an electrode active material. One example of such an electrode active material is a phosphate containing a transition metal and lithium. The olivine crystal structure is a crystal that natural olivine has, and can be identified by X-ray diffraction.

A typical example of an electrode active material having an olivine crystal structure is LiCoPO₄ containing Co. Phosphates in which the transition metal Co is replaced in this chemical formula can also be used. Here, the ratio of Li and PO₄ can vary depending on the valence. Note that it is preferable to use Co, Mn, Fe, Ni, or the like as the transition metal.

The second internal electrode 20 contains a negative electrode active material.

In the production of the first internal electrode 10 and the second internal electrode 20, in addition to these electrode active materials, a solid electrolyte having ion conductivity and a conductive material (conductive assistant) are added. For these components, a paste for the internal electrodes can be obtained by uniformly dispersing a binder and a plasticizer in water or an organic solvent. A carbon material or the like may be included as the conductive assistant. A metal may be included as the conductive assistant. Examples of metals for the conductive assistant include Pd, Ni, Cu, Fe, or alloys containing these. The solid electrolyte included in the first internal electrode 10 and the second internal electrode 20 can be the same as the main solid electrolyte of the solid electrolyte layer 30, for example.

In this embodiment, an AlM′₁₁O₂₉-based oxide having a monoclinic crystal lattice structure belonging to the space group C2/m is used as the negative electrode active material. AlM′₁₁O₂₉-based oxide has a low negative electrode operating potential, small volume change during charging and discharging, good cycle characteristics, and low weight-specific capacity. However, the volume-specific capacity is relatively high, making AlM′₁₁O₂₉-based oxide an ideal negative electrode active material for small all solid batteries in which the weight of the battery is not a major concern. In general, AlM′₁₁O₂₉ using Nb as M′ is widely known. However, the use of AlM′₁₁O₂₉ results in low cycle stability.

Therefore, in this embodiment, an AlNb₁₁₋ₓMₓO₂₉-based oxide (0≤x) in which a part of AlNb₁₁O₂₉ is replaced with a different metal element M is used as the negative electrode active material. A transition metal element with a valence of 4 or more is used as M. For example, Ta can be used as M. Specifically, an oxide that can be expressed by the formula AlNb₁₁₋ₓTaₓO₇ is used as the negative electrode active material.

However, if the value of x is too small, there is a risk of a decrease in cycle characteristics, and if it is too large, there is a risk of a secondary phase being generated, causing a decrease in capacity. Therefore, in this embodiment, the range of x is preferably 0.5<x<5, more preferably 0.7≤x≤4.0, and even more preferably 1.0≤x≤3.0.

In addition, if it is desired to avoid a decrease in capacity, it is possible to substitute another metal element for Al as in Patent Document 1, but reducing the amount of Al may cause a decrease in rate characteristics. In addition, as in Patent Document 1, it is possible to substitute Al with a divalent or monovalent element to express rate characteristics, but in an all solid battery using an oxide-based solid electrolyte, there is a risk that these low-valent elements will diffuse during co-firing. Therefore, although the metal element to be substituted is substituted at the Al site, it is preferable that the metal element to be substituted is substituted at the Nb site rather than the Al site. For Nb, other transition metal elements with a valence of 4 or more that form MO₆octahedrons similar to Ta can be suitably used. For example, Ti, Ge, Zr, Hf, V, W, Mo or the like can be used instead of Ta. In particular, Ta shows an oxidation-reduction reaction at a relatively close potential even when substituted for Nb, so it has been found that there is almost no capacity decrease with the decrease in the amount of Nb. The ratio of the number of atoms of Al, Nb, and Ta can be verified from the product after sintering (after densification) by LA-ICP-MS (laser ablation ICP mass spectrometry).

Here, Nb is generally prone to two-electron reactions (Nb⁵⁺→Nb⁴⁺→Nb³⁺), so the volume change accompanying Li insertion and removal becomes large, and it is thought that the cycle characteristics are likely to deteriorate. However, the above M is thought to be less prone to two-electron reactions than Nb. Therefore, by using the negative electrode active material that can be expressed by the composition formula AlNb₁₁₋ₓTaₓO₇ (0.5<x<5), the volume change associated with Li insertion and removal can be kept small, resulting in good cycle characteristics.

By using the negative electrode active material that can be expressed by the composition formula AlNb₁₁₋ₓMₓO₂₉ (0.5<x<5), the inter-diffusion reaction that occurs when the solid electrolyte layer 30 and the second internal electrode 20 are co-sintered can be suppressed. This is because the oxides containing the above-mentioned M as a main element are relatively stable, and element diffusion between the solid electrolytes is unlikely to occur when co-sintering is performed.

In the second internal electrode 20, if the average grain size of the negative active material is too large, the resistance inside the electrode may become high, making it difficult to charge and discharge at high speed. If the average grain size is too small, the reactivity during heat treatment may increase, and the sintering and densification of the solid electrolyte may be suppressed. Therefore, the average grain size of the negative active material in the second internal electrode 20 is preferably 0.5 μm or more and 5 μm or less, more preferably 0.7 μm or more and 3.0 μm or less, and even more preferably 1 μm or more and 3 μm or less.

In producing the all solid battery 100, a multilayer capacitor type structure in which the first internal electrode 10 and the second internal electrode 20 are alternately stacked in parallel with the solid electrolyte layer 30 interposed therebetween is suitable for miniaturization while increasing the capacity density. In this case, it is preferable to make the thickness of the first internal electrode 10 and the thickness of the second internal electrode 20 approximately the same, but since the negative electrode active material provided by this embodiment has a higher capacity per volume than a general positive electrode active material, it is preferable to balance the capacity by putting more positive electrode active material than the volume of the negative electrode active material. Therefore, the first internal electrode 10 can be balanced by putting an active material with high electronic conductivity in a volume greater than the volume of the negative electrode active material to reduce the conductive assistant, or putting an active material with high ionic conductivity in a volume greater than the volume of the negative electrode active material to reduce the ion conductive assistant. It is preferable to put LiCoPO₄, which has high electronic conductivity after charging, in a volume greater than the volume of the negative electrode active material and to put a conductive assistant less than the volume of the negative electrode conductive assistant, thereby balancing the capacity and electronic conductivity. When the first internal electrode 10 and the second internal electrode 20 have approximately the same thickness, it is necessary to make the volume ratio of the negative electrode active material smaller than the volume ratio of the positive electrode active material in order to achieve a capacity balance, so the volume ratio of the negative electrode active material in the second internal electrode 20 is preferably about 20 to 60 vol. %.

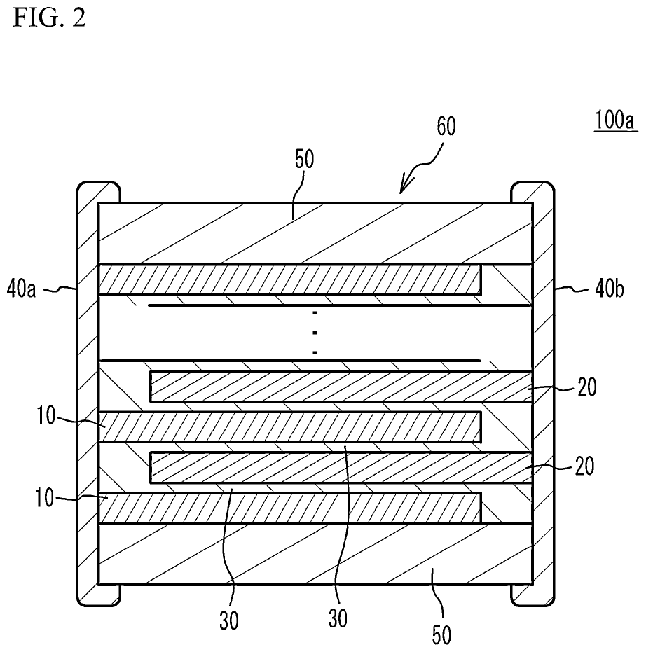

FIG. 2 is a cross-sectional view of a stacked all solid battery 100a in which a plurality of battery units are stacked. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of first internal electrodes 10 and the plurality of second internal electrodes 20 are alternately stacked with the solid electrolyte layers 30 in between. The edges of the plurality of first internal electrodes 10 are exposed to the first end face of the multilayer chip 60 and are not exposed to the second end face. The edges of the plurality of second internal electrodes 20 are exposed to the second end face of the multilayer chip 60 and are not exposed to the first end face. Thereby, the first internal electrode 10 and the second internal electrode 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper face of the multilayer structure of the first internal electrode 10, the solid electrolyte layer 30, and the second internal electrode 20 (in the example of FIG. 2, the upper face of the first internal electrode 10 of the uppermost layer). In addition, another cover layer 50 is stacked on the lower face of the multilayer structure (in the example of FIG. 2, the lower face of the first internal electrode 10 of the lowermost layer). The cover layer 50 is mainly composed of an inorganic material (for example, Al₂O₃, ZrO₂, TiO₂ or the like) containing, for example, Al, Zr, Ti, or the like. The cover layer 50 may contain the main component of the solid electrolyte layer 30 as a main component.

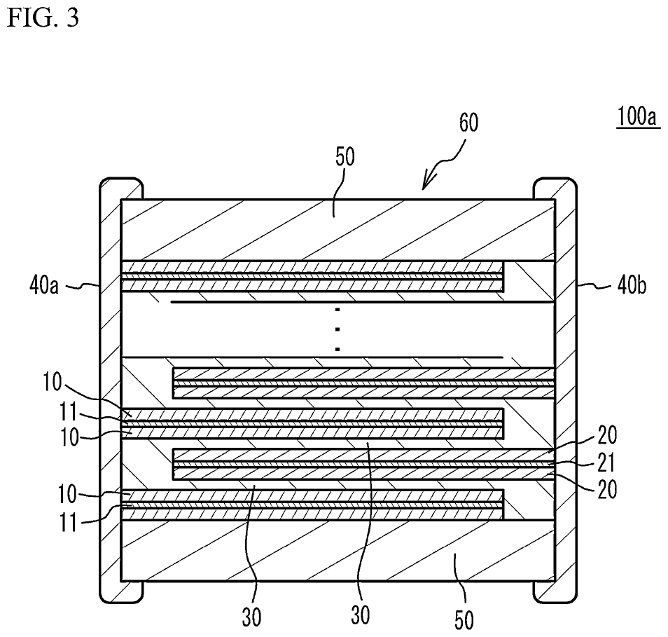

Each of the first internal electrode 10 and the second internal electrode 20 may include a current collector layer. For example, as illustrated in FIG. 3, a first current collector layer 11 may be provided within the first internal electrode 10. Further, a second current collector layer 21 may be provided within the second internal electrode 20. The first current collector layer 11 and the second current collector layer 21 have a conductive material as a main component. For example, metal, carbon, or the like can be used as the conductive material for the first current collector layer 11 and the second current collector layer 21. By connecting the first current collector layer 11 to the first external electrode 40a and connecting the second current collector layer 21 to the second external electrode 40b, current collection efficiency is improved.

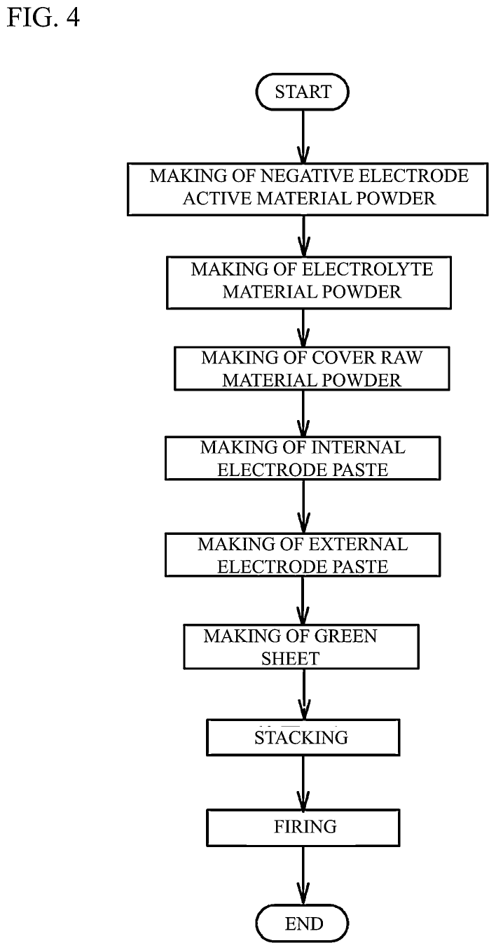

A description will be given of a manufacturing method of the all solid battery 100a described on the basis of FIG. 2. FIG. 4 illustrates a flowchart of the manufacturing method of the all solid battery 100a.

(Process for producing negative electrode active material powder) Raw materials such as Al₂O₃, Nb₂O₅, and Ta₂O₅ are weighed out so that the composition is AlNb₁₁₋ₓMₓO₂₉ (0.5<x<5), then crush and mix. After mixing, the raw materials are calcined at 1100° C. in air, and the calcined powder is crushed again. Then, heat treat at 1300° C. in air to obtain the desired AlNb₁₁₋ₓMₓO₂₉ (0.5<x<5) synthetic powder. After crushing the synthetic powder again, sieving is performed through a #150 stainless steel mesh to obtain the negative electrode active material powder.

If the calcination temperature during synthesis is too high, the particles will adhere to each other and become difficult to handle, which is not desirable, and if it is too low, the uniformity of the metal atoms will decrease, which is not desirable. The firing temperature is preferably from 1100° C. to 1400° C., more preferably from 1150° C. to 1350° C., and even more preferably from 1200° C. to 1300° C.

(Making process of raw material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ.

(Making process of raw material powder for cover layer) A raw material powder of ceramics for the cover layer 50 is made. For example, the raw material powder for the cover layer can be prepared by mixing the raw materials, additives, and so on and using a solid-phase synthesis method, or the like. The obtained raw material powder can be dry-milled to adjust the average particle size to the desired size. For example, the desired average particle size is adjusted using a planetary ball mill using ZrO₂ ball of 5 mm ϕ.

(Making process for electrode layer paste) Next, internal electrode pastes for making the first internal electrode 10 and the second internal electrode 20 described above are made. For example, a paste for internal electrodes can be obtained by uniformly dispersing a conductive assistant, an electrode active material, a solid electrolyte material, a sintering aid, a binder, a plasticizer and so on in water or an organic solvent. The solid electrolyte paste described above may be used as the solid electrolyte material. A carbon material or the like is used as a conductive assistant. A metal may be used as the conductive assistant. Examples of the metal of the conductive assistant include Pd, Ni, Cu, Fe, or alloys containing these. Pd, Ni, Cu, Fe, alloys containing these, various carbon materials, and so on may also be used. When the first internal electrode 10 and the second internal electrode 20 have different compositions, the respective internal electrode pastes may be prepared separately.

The sintering aid of the internal electrode paste contains one or more glass components such as a Li—B—O based compound, a Li—Si—O based compound, a Li—C—O based compound, a Li—S—O based compound, or a Li—P—O based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

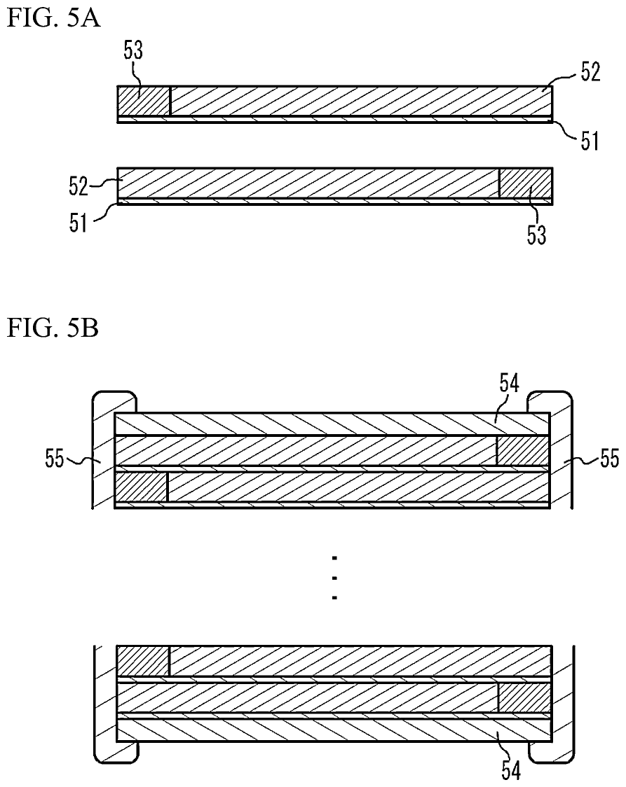

(Stacking process) As illustrated in FIG. 5A, an internal electrode paste 52 is printed on one side of the solid electrolyte green sheet 51. A reverse pattern 53 is printed on the peripheral area of the solid electrolyte green sheet 51 where the internal electrode paste 52 is not printed. The same material for the solid electrolyte green sheet 51 ca be used as the reverse pattern 53. The solid electrolyte green sheet 51 after the printing can be used as a stack unit. The plurality of solid electrolyte green sheets 51 are stacked so as to be alternately shifted. As illustrated in FIG. 5B, a multilayer structure is obtained by pressing a cover sheet 54 from above and below in the stacking direction. In this case, in the multilayer structure, the internal electrode paste 52 for the first internal electrode 10 is exposed on one end surface, and the internal electrode paste 52 for the second internal electrode 20 is exposed on the other end surface. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an eternal electrode paste 55 is applied to two end faces of the multilayer structure by dipping or the like and is dried. Thus, a compact for forming the all solid battery 100a is obtained.

(Firing process) Next, the resulting ceramic multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Through the processes, the all solid battery 100a is formed.

Furthermore, by sequentially stacking the internal electrode paste, the collector paste containing a conductive material, and the internal electrode paste, a collector layer can be formed within the first internal electrode 10 and the second internal electrode 20.

### EXAMPLES

(Comparative Example 1) The raw materials Al₂O₃ and Nb₂O₅ were weighed out in a molar ratio of 1:1 to obtain the composition ratio of AlNb₁₁O₂₉, and were crushed and mixed. After mixing, the mixture was calcined at 1100° C. in air, and the calcined powder obtained was crushed again and further heat-treated at 1300° C. in air to obtain the desired AlNb₁₁O₂₉ synthetic powder. The synthetic powder was crushed again, and then sieved through a #150 stainless steel mesh to obtain the negative electrode active material powder. XRD measurement showed the same diffraction peak as AlNb11O29, but no other secondary phase peaks were observed.

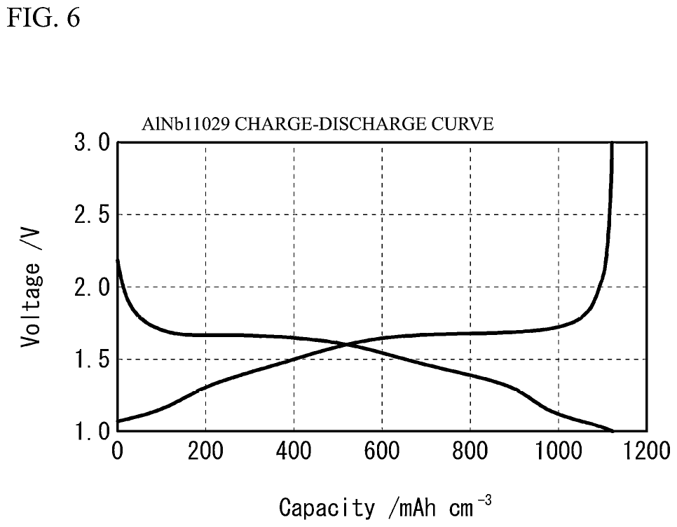

A coating slurry consisting of negative electrode active material powder, PVdF binder, acetylene black, and NMP was prepared, and a coating film was formed on a copper foil. A negative electrode half-cell with metallic lithium foil placed on the counter electrode was sealed in a 2032 coin cell. A charge/discharge test was performed in the range of 3 to 1 V at 25° C. and a charge/discharge rate of 0.1 C. FIG. 6 shows the results of the charge/discharge test.

The initial discharge capacity at the 1.0 V cutoff was 1122 mAh/cm³. The discharge capacity after 100 cycles (capacity retention rate) relative to the initial discharge capacity was 80.5%. The capacity ratio to 0.5 C discharge at a discharge rate of 5 C was 81%. An experiment was performed in which this negative electrode active material was mixed with solid electrolyte LAGP in a 50:50 volume ratio and heat-treated in air, and no heterogeneous phase formation was observed up to 660° C. That is, the maximum temperature at which the batch firing was possible was 660° C.

(Comparative Example 2) Negative electrode active material powder was prepared and evaluated in the same manner as in Comparative Example 1, except that the raw materials Al₂O₃, Nb₂O₅, and Ta₂O₅ were weighed in a molar ratio of 1:10.5:0.5 to obtain the composition ratio of AlNb_{10.5}Ta_{0.5}O₂₉. XRD measurements showed that the same diffraction peak as AlNb₁₁O₂₉ was the main phase, and the single-phase rate estimated from the intensity ratio of the main peak of the main phase and the main peak of the secondary phase was 99%.

A negative electrode half-cell was prepared and charged and discharged in the same manner as in Comparative Example 1, and the initial discharge capacity at the 1.0V cutoff was 867mAh/cm³. The discharge capacity after 100 cycles was 72.6% of the initial discharge capacity. The capacity ratio at a discharge rate of 5C to a discharge rate of 0.5C was 74%.

This negative electrode active material was mixed with solid electrolyte LAGP in a volume ratio of 50:50 and heat-treated in air, and no heterogeneous phase formation was observed up to 670° C.

(Example 1) A negative electrode active material powder was prepared and evaluated in the same manner as in Comparative Example 1, except that the raw materials Al₂O₃, Nb₂O₅, and Ta₂O₅ were weighed in a molar ratio of 1:10:1 to obtain the composition ratio of AlNb₁₀TaO₂₉. XRD measurement revealed the same diffraction peak as AlNb₁₁O₂₉ as the main phase, and the single-phase rate estimated from the intensity ratio of the main peak of the main phase and the main peak of the secondary phase was 98%.

A negative electrode half-cell was prepared and a charge-discharge test was performed in the same manner as in Comparative Example 1, and the initial discharge capacity at the 1.0V cutoff was 922mAh/cm³. The discharge capacity after 100 cycles was 80.1% of the initial discharge capacity. The capacity ratio for 0.5C discharge at a discharge rate of 5C was 78%.

In an experiment in which this negative electrode active material was mixed with solid electrolyte LAGP in a volume ratio of 50:50 and heat-treated in air, no heterogeneous phase formation was observed up to 700° C.

(Example 2) A negative electrode active material powder was produced and evaluated in the same manner as in Comparative Example 1, except that the raw materials Al₂O₃, Nb₂O₅, and Ta₂O₅ were weighed in a molar ratio of 1:9.5:1.5 to obtain the composition ratio of AlNb_{9.5}Ta_{1.5}O₂₉. XRD measurement revealed the same diffraction peak as AlNb₁₁O₂₉ as the main phase, and the single-phase rate estimated from the intensity ratio of the main peak of the main phase to the main peak of the secondary phase was 96%.

A negative electrode half-cell was prepared in the same manner as in Comparative Example 1, and a charge-discharge test was performed. The initial discharge capacity at 1.0 V cutoff was 977 mAh/cm³. The discharge capacity after 100 cycles was 86.2% of the initial discharge capacity. The capacity ratio to 0.5 C discharge at a discharge rate of 5 C was 82%.

In an experiment in which this negative electrode active material was mixed with solid electrolyte LAGP in a volume ratio of 50:50 and heat-treated in air, no heterogeneous phase formation was observed up to 710° C.

(Example 3) A negative electrode active material powder was prepared and evaluated in the same manner as in Comparative Example 1, except that the raw materials Al₂O₃, Nb₂O₅, and Ta₂O₅ were weighed in a molar ratio of 1:9:2 to obtain the composition ratio of AlNb₉Ta₂O₂₉. XRD measurements showed that the same diffraction peaks as AlNb₁₁O₂₉ were observed as the main phase, and the single-phase rate estimated from the intensity ratio of the main peak of the main phase to the main peak of the secondary phase was 90%.

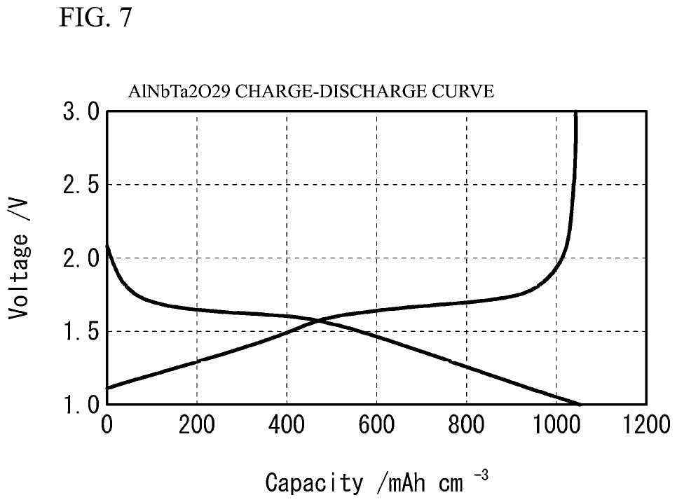

A negative electrode half-cell was prepared in the same manner as in Comparative Example 1, and a charge-discharge test was performed. FIG. 7 shows the results of the charge-discharge test. The initial discharge capacity at the 1.0 V cutoff was 1042 mAh/cm³. The discharge capacity after 100 cycles was 90.7% of the initial discharge capacity. The capacity ratio to 0.5 C discharge at a discharge rate of 5 C was 82%.

In an experiment in which this negative electrode active material was mixed with solid electrolyte LAGP in a 50:50 volume ratio and heat-treated in air, no heterogeneous phase formation was observed up to 710° C.

(Example 4) A negative electrode active material powder was prepared and evaluated in the same manner as in Comparative Example 1, except that the raw materials Al₂O₃, Nb₂O₅, and Ta₂O₅ were weighed in a molar ratio of 1:8:3 to obtain the composition ratio of AlNb₈Ta₃O₂₉. XRD measurements showed that the same diffraction peak as AlNb₁₁O₂₉ was the main phase, and the single-phase rate estimated from the intensity ratio of the main peak of the main phase to the main peak of the secondary phase was 62%.

A negative electrode half-cell was prepared and charged and discharged in the same manner as in Comparative Example 1, and the initial discharge capacity at the 1.0V cutoff was 733mAh/cm³. The discharge capacity after 100 cycles was 87.5% of the initial discharge capacity. The capacity ratio to 0.5C discharge at a discharge rate of 5C was 73%.

In an experiment in which this negative electrode active material was mixed with solid electrolyte LAGP in a volume ratio of 50:50 and heat-treated in air, no heterogeneous phase formation was observed up to 720° C.

(Comparative Example 3) A negative electrode active material powder was prepared and evaluated in the same manner as in Comparative Example 1, except that the raw materials Al₂O₃, Nb₂O₅, and Ta₂O₅ were weighed in a molar ratio of 1:6:5 to obtain the composition ratio of AlNb₆Ta₅O₂₉. XRD measurements showed some diffraction peaks identical to those of AlNb₁₁O₂₉, and the single-phase rate estimated from the intensity ratio of the peaks attributed to AlNb₁₁O₂₉ and the main peak of the secondary phase was 39%.

A negative electrode half-cell was prepared and a charge-discharge test was performed in the same manner as in Comparative Example 1, and the initial discharge capacity at the 1.0V cutoff was 231mAh/cm³. The discharge capacity after 100 cycles was 68.2% of the initial discharge capacity. The capacity ratio at a discharge rate of 5C to a discharge rate of 0.5C was 69%.

In an experiment in which this negative electrode active material was mixed with solid electrolyte LAGP in a volume ratio of 50:50 and heat-treated in air, no heterogeneous phase formation was observed up to 720° C.

(Comparative Example 4) A negative electrode active material powder was prepared and evaluated in the same manner as in Comparative Example 1, except that the raw materials Al₂O₃, Ta₂O₅, and Nb₂O₅ were weighed in a molar ratio of 0.5:0.5:11 to obtain a composition ratio of Al_{0.5}Ta_{0.5}Nb₁₁O₂₉. XRD measurements showed some diffraction peaks identical to those of AlNb₁₁O₂₉, and the single-phase rate estimated from the intensity ratio of the peaks attributed to AlNb₁₁O₂₉ and the main peak of the secondary phase was 73%.

When a negative electrode half-cell was prepared and a charge/discharge test was conducted in the same manner as in Comparative Example 1, the initial discharge capacity at 1.0 V cutoff was 732 mAh/cm³. The discharge capacity after 100 cycles was 69.6% of the initial discharge capacity. The capacity ratio to 0.5 C discharge at a discharge rate of 5 C was 52%.

When this negative electrode active material was mixed with solid electrolyte LAGP in a 50:50 volume ratio and heat-treated in air, no heterogeneous phase formation was observed up to 700° C.

When the XRD results of the negative electrode active material synthetic powder showed a single-phase rate of 80% or more, it was judged as good “○”; when it was 50% or more but less than 80%, it was judged as somewhat good “Δ”; and when it was less than 50%, it was judged as bad “x”. If the initial discharge capacity was 800 mAh/cm³ or more, it was judged as good “○”, if it was 700 mAh/cm³ or more but less than 800 mAh/cm³, it was judged as somewhat good “Δ”, and if it was less than 700 mAh/cm³, it was judged as bad “x”. If the discharge capacity after 100 cycles was 80% or more of the initial discharge capacity, it was judged as good “○”, and if it was less than 80%, it was judged as bad “x”. If the capacity ratio to 0.5C discharge at a discharge rate of 5C was 70% or more, it was judged as good “○”, if it was 60% or more but less than 70%, it was judged as somewhat good “Δ”, and if it was less than 60%, it was judged as bad “x”. If the maximum temperature at which no heterogeneous phase formation was observed in the heat treatment with the solid electrolyte was 700° C. or more, it was judged as good “○”, and if it was less than 700° C., it was judged as bad “x”.

An overall judgment was made based on the five judgements. The overall judgement was judged as good “○” if there was no “x” in any of the five judgements, and the overall judgement was judged as bad “x” if there was even one “x”. The above results are summarized in Tables 1 and 2.

TABLE 1

| | | SINGLE | | DISCHARGE | |
|---|---|---|---|---|---|
| | | PHASE | | CAPACITY | |
| | FORMULA | RATE | JUDGE | (mAh/cm³) | JUDGE |
| COMPARATIVE | AlNb₁₁O₂₉ | 100% | ∘ | 1122 | ∘ |
| EXAMPLE 1 | | | | | |
| COMPARATIVE | AlNb1_{0.5}Ta_{0.5}O₂₉ | 99% | ∘ | 867 | ∘ |
| EXAMPLE 2 | | | | | |
| EXAMPLE 1 | AlNb₁₀TaO₂₉ | 98% | ∘ | 922 | ∘ |
| EXAMPLE 2 | AlNb_{9.5}Ta_{1.5}O₂₉ | 96% | ∘ | 977 | ∘ |
| EXAMPLE 3 | AlNb₉Ta₂O₂₉ | 90% | ∘ | 1042 | ∘ |
| EXAMPLE 4 | AlNb₈Ta₃O₂₉ | 62% | Δ | 733 | Δ |
| COMPARATIVE | AlNb₆Ta₅O₂₉ | 39% | x | 231 | x |
| EXAMPLE 3 | | | | | |
| COMPARATIVE | Al_{0.5}Ta_{0.5}Nb₁₁O₂₉ | 73% | Δ | 732 | Δ |
| EXAMPLE 4 | | | | | |

TABLE 2

| | | | | | | MAXIMUM | | |
|---|---|---|---|---|---|---|---|---|
| | | | | RATE | | TEMPERATURE | | |
| | | CAPACITY | | CHARACTERISTIC | | AT WHICH | | |
| | | RETENSION | | 5 C/0.5 C | | BATCH | | |
| | | RATE | | CAPACITY | | FIRING IS | | OVERALL |
| | FORMULA | (%) | JUDGE | RATIO | JUDGE | POSSIBLE. | JUDGE | JUDGE |
| COMPARATIVE | AlNb₁₁O₂₉ | 80.5 | ∘ | 81% | ∘ | 660° C. | x | x |
| EXAMPLE 1 | | | | | | | | |
| COMPARATIVE | AlNb_{10.5}Ta_{0.5}O₂₉ | 72.6 | x | 74% | ∘ | 670° C. | x | x |
| EXAMPLE 2 | | | | | | | | |
| EXAMPLE 1 | AlNb₁₀TaO₂₉ | 80.1 | ∘ | 78% | ∘ | 700° C. | ∘ | ∘ |
| EXAMPLE 2 | AlNb_{9.5}Ta_{1.5}O₂₉ | 86.2 | ∘ | 82% | ∘ | 710° C. | ∘ | ∘ |
| EXAMPLE 3 | AlNb₃Ta₂O₂₉ | 90.7 | ∘ | 82% | ∘ | 710° C. | ∘ | ∘ |
| EXAMPLE 4 | AlNb₃Ta₃O₂₉ | 87.5 | ∘ | 73% | ∘ | 720° C. | ∘ | ∘ |
| COMPARATIVE | AlNb₃Ta₅O₂₉ | 68.2 | x | 69% | Δ | 720° C. | ∘ | x |
| EXAMPLE 3 | | | | | | | | |
| COMPARATIVE | Al_{0.5}Ta_{0.5}Nb₁₁O₂₉ | 69.6 | x | 52% | x | 700° C. | ∘ | x |
| EXAMPLE 4 | | | | | | | | |

As shown in Tables 1 and 2, in Examples 1 to 4, the overall judgement was judged as good “○”. This is thought to be because a negative electrode active material was used that was represented by the composition formula AlNb₁₁₋ₓMₓO₂₉, where 0.5<x<5, and M was a transition metal element with a valence of 4 or more. On the other hand, in Comparative Examples 1 to 4, the overall judgement was judged as bad “x”. This is thought to be because a negative electrode active material was used that did not satisfy the conditions “represented by the composition formula AlNb₁₁₋ₓMₓO₂₉, where 0.5<x<5, and M was a transition metal element with a valence of 4 or more”.

Comparing the charge/discharge curve of AlNb₁₁O₂₉ in Comparative Example 1 with that of AlNb₉Ta₂O₂₉ in Example 3, it can be seen that there is a difference in the shape of the charge/discharge curve at the end of charging (Li insertion), which is a factor in the cycle degradation of AlNb₁₁O₂₉. This is thought to be due to the stabilization of the crystal structure caused by Ta doping. It is known that AlNb₁₁O₂₉ shows significant degradation behavior when Li is inserted up to a region of approximately 1.4 V vs Li/Li⁺ or less. The reason why the charge/discharge curve in this region becomes stepped is thought to be due to a large structural change caused by Li insertion, and the structural change is thought to be minor due to Ta doping, resulting in a continuous charge/discharge curve and improved cycle stability.

Although the embodiments of the present invention have been described in detail, it is to be understood that the various change, substitutions, and alterations could be made hereto without departing from the spirit and scope of the invention.

1. A negative electrode active material, wherein:
a composition is expressed by a formula AlNb₁₁₋ₓMₓO₂₉;
0.5<x<5 is satisfied; and
the M is a transition metal element with a valence of 4 or more.

2. The negative electrode active material as claimed in claim 1,
wherein the negative electrode active material has a monoclinic crystal lattice structure belonging to a space group C2/m.

3. The negative electrode active material as claimed in claim 1,
wherein the M is Ta.

4. An all solid battery comprising:
an oxide-based solid electrolyte layer;
a first electrode layer that is formed on a first main face of the oxide-based solid electrolyte layer and includes a positive electrode active material; and
a second electrode layer that is formed on a second main face of the oxide-based solid electrolyte layer and includes a negative electrode active material as claimed in claim 1.

5. The all solid battery as claimed in claim 4,
wherein an average grain diameter of the negative electrode active material in the second electrode layer is 0.5 μm or more and 5 μm or less.
